(19) United States
(12) Patent Application Publication
(10) Pub. No.: US 2021/0256563 A1
(43) Pub. Date: Aug. 19, 2021

(54) MARKET ENGAGEMENT SYSTEM AND METHOD

(71) Applicant: A4R4 Media LLC d/b/a BrandCloud, Wilton, CT (US)

(72) Inventors: Martin Matthew Bostwick, Wilton, CT (US); Randall Lacey Mullins, Brooklyn, NY (US)

(21) Appl. No.: 16/876,778

(22) Filed: May 18, 2020

Related U.S. Application Data
(60) Provisional application No. 62/849,318, filed on May 17, 2019.

(51) Int. Cl. G06Q 30/02

(52) U.S. Cl. CPC G06Q 30/0269; G06Q 30/0242; G06Q 30/0277; G06Q 30/0276

(57) ABSTRACT

A method for driving trial of a branded product can include defining objectives for a marketing campaign and discovering target brand users. The target brand users comprise loyal branded product users. The method can also include determining life motivators of the target brand users, determining brand motivators of the target brand users, and designing an online engagement activity related to the branded product. The online engagement activity tracks conversion rates related to the branded product. The method can also include engaging the target brand users in use of the online engagement activity.

REFERENCE TO RELATED APPLICATIONS

This application claims the priority benefit of U.S. Provisional Patent App. No. 62/849,318, filed May 17, 2019, which is incorporated herein by reference in its entirety.

### TECHNICAL FIELD

Embodiments of the technology relate, in general, to systems and methods for engaging branded product users in market development of branded products.

### BACKGROUND

Marketers of branded products seek to engage more users of the branded products. Typically, marketers use advertising to provide information about a branded product in an effort to prompt purchase of the branded product by persons who had not previously purchased the product. Advertising is typically achieved by providing brand information in media such as newspapers, magazines, both digital and paper.

In the age of social media, marketers have sought to harness the power of data-driven connections to target advertising. However, current methods and systems fall short of achieving desired returns on investment in social media advertising. Social media agencies, for example, are focused on increased engagement in social media, yet often do not realize successful conversions to purchase. This is believed to be because current systems and methods for digital advertising on social media are focused on collecting data or managing social media accounts for unfocused advertising, as opposed to efficiently producing new customers of branded products.

Accordingly, there is a continuing unmet need for improved systems and methods for increasing returns on investment in social media advertising.

Further, there is a continuing unmet need for systems and methods for leveraging loyal branded product users to drive trial and use by new customers of branded products.

Additionally, there is a continuing unmet need for systems and methods for harnessing the potential of online gaming to drive brand exposure.

### SUMMARY

In an embodiment, a method for driving trial of a branded product can include defining objectives for a marketing campaign and discovering target brand users. The target brand users comprise loyal branded product users. The method can also include determining life motivators of the target brand users, determining brand motivators of the target brand users, and designing an online engagement activity related to the branded product. The online engagement activity tracks conversion rates related to the branded product. The method can also include engaging the target brand users in use of the online engagement activity.

### BRIEF DESCRIPTION OF THE DRAWINGS

The present disclosure will be more readily understood from a detailed description of some example embodiments taken in conjunction with the following figures.

FIG. 1 is schematic representation of an embodiment of a system of the present disclosure.

FIG. 2 is a flow diagram of a method of an embodiment of the present disclosure.

FIG. 3 is a continuation of the flow diagram of FIG. 2.

FIG. 4 is a representative depiction of program obj ectives of an exemplary system and method of the present disclosure.

FIG. 5 is a representative depiction of a user profile in an exemplary system and method of the present disclosure.

FIG. 6 is a representative depiction of identification of social attributes in an exemplary system and method of the present disclosure.

FIG. 7 is a representative depiction of target brand user engagement activity in an exemplary system and method of the present disclosure.

FIG. 8 is a representative depiction of target brand user engagement activity in an exemplary system and method of the present disclosure.

FIG. 9 is a representative depiction of the results of a campaign of an exemplary system and method of the present disclosure.

FIG. 10 is a representative depiction of the results of a campaign of an exemplary system and method of the present disclosure.

### DETAILED DESCRIPTION

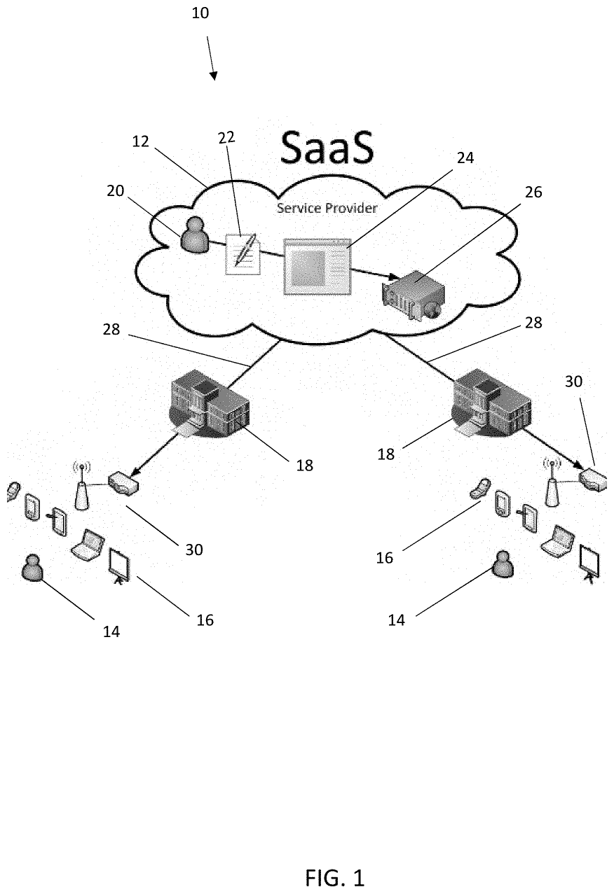

Certain embodiments are hereinafter described in detail in connection with the views and examples of FIGS. 1-10, wherein like numbers refer to like elements throughout the views.

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Described herein are solutions to the problems associated with digital marketing. Specifically, the systems and methods disclosed herein enable branded product marketers, e.g., brand managers, marketing managers, and the like, to identify and leverage loyal branded product users with the goal of finding and producing new branded product users. Further, the systems and methods disclosed herein enable the branded product marketers to forecast the impact current branded product users can have on sales of the branded product.

As described more fully below, the systems and methods described herein utilize information derived from research of interactions with branded product consumers to identify target brand users. Target brand users, as used herein, are considered to be a brand's most loyal and active users as indicated by data gathered from social media. Target brand users can be termed “superfans,” as the term is currently in use. In an embodiment, it is believed that target brand users comprise less than 5% of a total customer base that represents 99% of a branded product's social media advocacy. But target brand users can love the branded product and/or the brand with a passion that defines them. For example, target brand users can possess an undying loyalty to the brand as a code of honor, and are willing to do brand advocacy on behalf of the branded product maker, including as a personal crusade. Target brand users often will join and engage in activities related to the brand, and want to be part of a brand team and be recognized personally by the brand. Thus, target brand users are valuable consumers of a subject branded product and, if identified and engaged, can be leveraged to drive conversion of trial use of the subject branded product among others.

Data gathered for target brand users can include behavioral profiles and can be used to identify what motivates a target brand user to use, and possibly, advocate for a brand. By the systems and methods disclosed herein, a target brand user can be identified and recruited by the brand owner, such as a brand manager, to take steps that cause the target brand user's social media contacts to become aware of, and purchase the branded product. The brand owner can, for example, provide to a target brand user an online engagement activity, such as a game or other challenge, that motivates the target brand user to advocate for the brand to others, including his or her social media contacts.

Referring now to FIG. 1, a representative system 10 for executing a method of the present disclosure is shown. The system 10 can comprise a cloud-based software-as-a-service (SaaS) architecture 12, built for brand advocacy, marketing intelligence, and marketing ROI. The technology can use machine learning of a target brand user's behavioral data to execute marketing programs for a client 14 who can be, for example, a brand manager for a branded product owner 18. The product owner 18 can be a company producing and marketing a branded product. SaaS can comprise a software licensing and delivery business model in which software is licensed, e.g., on a subscription basis, and is centrally hosted. Clients and other users can access the service via, e.g., web browsers. A service provider 20 can design 22, implement 24, operate/host 26, and sell 28 the service to a product owner 18 and/or a client 14. In an embodiment, a client 14 can use one or more input/output devices 16, such as a web browser, a mobile app, a thin client, and/or a terminal emulator to access the SaaS system 10 via network devices, including wired and wireless devices 30.

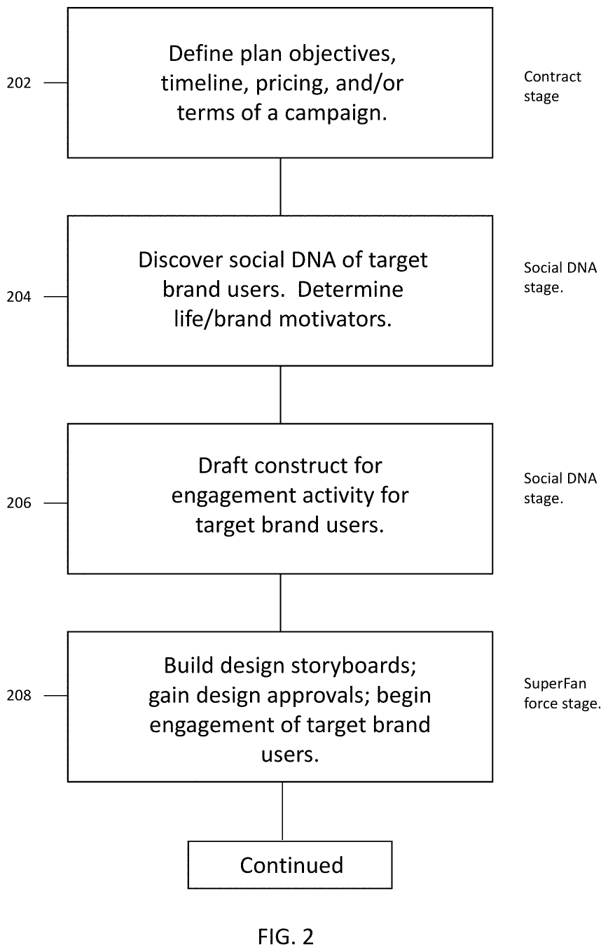

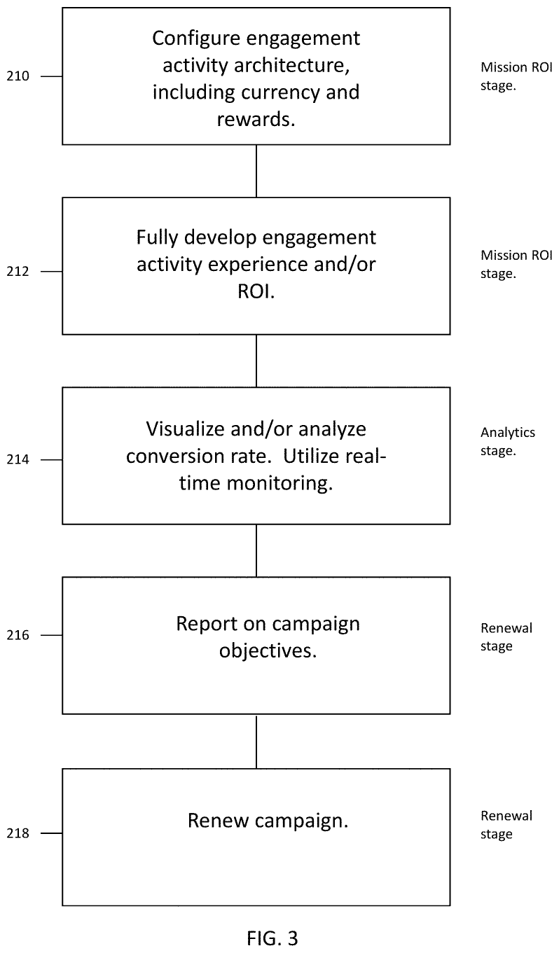

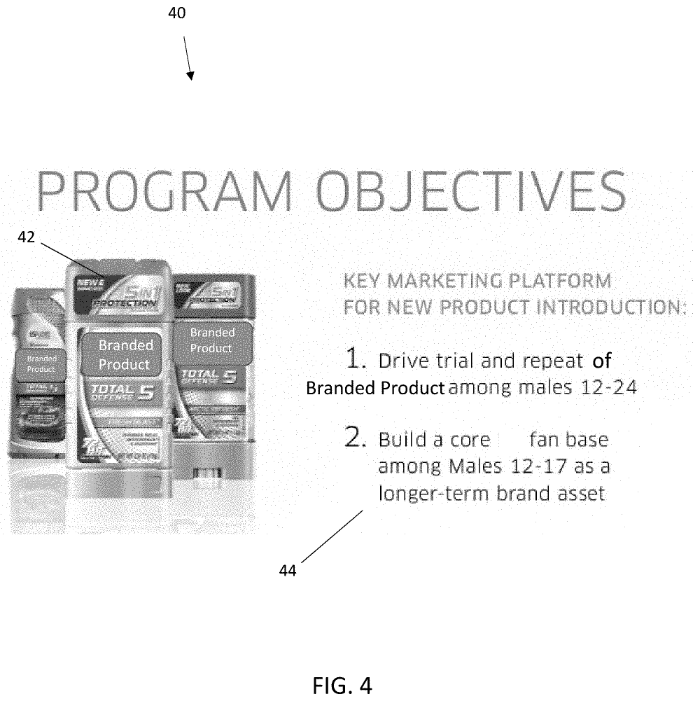

In an exemplary embodiment, the system and method can be described with respect to the method 200 described in the flow diagram of FIGS. 2 and 3. In a contract stage 202, the service provider 20 and the client 14 can discuss and agree on a proposed template, timeline, pricing, and deliverables for engaging target brand users to become advocates for a subject branded product in a contracted campaign. At this stage, various responsibilities can be identified and assigned, such as lead contacts for both the service provider and the client during the campaign. For example, as shown in FIG. 4, program objectives 40 can be proposed and agreed upon for a branded product 42. Program objectives can include, for example, objective goals 44 for driving trial and repeat purchase of the branded product 42 by a particular demographic of users.

At step 204, the service provider utilizes social media and data derived from social media to identify target brand users, again, so-called “superfans” of the subject branded product 42. In an embodiment, the information gathered to identify target brand users can be considered the “social DNA” of a target brand user, or, in the aggregate, target brand users. The service provider can use the information gathered to create a target brand user profile including, for example, the target brand user's life motivators, brand motivators, heavy engagement areas, and trigger points. In a sense, the “social DNA” of a target brand user can be considered to comprise insights related to connection of life motivators and brand motivators, as discussed more fully below.

The system 10, in effect, pieces together algorithms developed from market research of real interactions with millions of consumers to identify a brand's most active customers and develop behavioral profiles that outline what motivates them to purchase and advocate for the brand. This “social DNA” can then be used to recruit a “force” of target brand users, and through the engagement activity “missions” discussed herein, the system can provide objective-focused challenges that operationalize ROI for the brand's marketing via the method of the present disclosure. In an embodiment, a proprietary deep learning algorithm can be utilized to collect, rank and weight existing brand consumer social engagement against potential brand superfan social engagement. The algorithm can help brands understand their likelihood of leveraging their superfans' social graphs for their specific industry category.

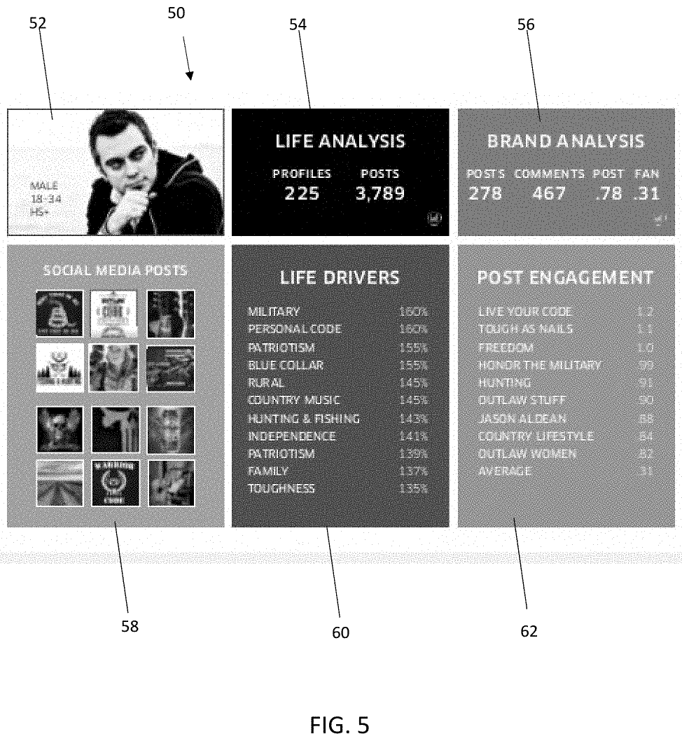

The identification of target brand users, and their associated “social DNA” can be achieved by employing social listening tools that can be automated and deployed digitally. For example, artificial intelligence tools can utilize algorithms and mathematical models to “slice and dice” the data for actionable insights. Target brand users' social topics, relationships and engagement intensities can be analyzed to identify behavioral patterns, correlations, and motivations at a plurality of relevant levels. For example, as shown in FIG. 5 showing an example summary analysis 50 of a target brand user 52 for a subject target brand, the data can be analyzed in terms of a life analysis 54 and a brand analysis 56. A candidate target brand user 52 can be identified by analyzing social media posts 58 to derive life drivers 60 and post engagement 62. Automated digital text mining of social media posts can be used, for example, to find that a candidate target brand user 52 values in life, for example, the military, patriotism, blue collar, rural, and the like. In addition, automated digital sifting of post engagement can identify values a target brand user attributes to a brand, such as “live by your code,” “tough as nails,” celebrity associations, sports, hobbies, and the like. Using algorithms to identify, rank, and weight the various life drivers and brand motivators, the system can identify and visualize a target brand user, such as in a visualization 64 as described below, or a candidate target brand user 52 as a potential target brand user.

As discussed herein, the systems and methods of the present disclosure can drive socialized purchase and trial at retail and ecommerce, to research for actionable marketing intelligence, and for brand advocacy based upon the brand's business objectives. Missions can be customized short term marketing programs run as gamified (using status and rewards—points, virtual currency, levels, leaderboards) creative campaigns based on data from social DNA profiles. The target brand user advocates can be recruited for the missions, receive mission-specific training. The subject branded owner can create a custom message and choose any offers that superfans can share with their social graph to achieve conversions for purchase at retail or ecommerce, collect research for brand initiatives, or provide specified brand advocacy for social currency.

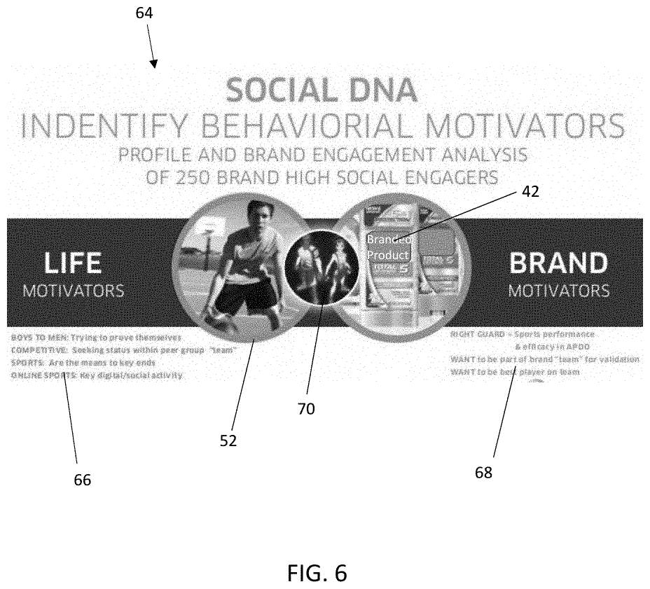

Referring to FIG. 6 there is shown another embodiment of a visualization 64 of life motivators 66 and brand motivators 68 for a subject branded product 42. Utilizing the analysis of social media, for example, algorithms and models of the system can be utilized to identify a quantity of brand high social engagers 70. The behavioral motivators of these identified brand high social engagers can be derived from social media posts, and can be categorized as life motivators 66 or brand motivators 68. Life motivators 66 can include values and aspirations related to living, such as “trying to prove themselves,” and “seeking status win peer group “team,” and the like. Brand motivators 68 can include desired attributes such as “sports performance and efficacy in antiperspirant and deodorant,” “be best player on the team,” and the like.

Once a target brand user and/or a target brand user profile is formulated, the service provider can then draft an initial construct for an engagement activity for the target brand users. An engagement activity can be, for example, an online, i.e., digital, game, an online challenge, an online rewards program, or the like, designed to engage the target brand user in an activity that can be leveraged into organic social engagement with other, potential brand users. In an embodiment, the aggregate of target brand uses can be considered a “force” of brand fans, and the engagement of this force of brand fans can be harnessed to drive brand trial and consumption by others.

Once a force of target brand users has been identified and a tailored engagement activity has been proposed, at step 208 the service provider can design an execution program, which can, for example, involve designing storyboards, wireframes, and proposed engagement activities and recruitment challenges for the identified target brand users. The storyboards can outline a proposed engagement strategy based on the identified target brand users, and can be delivered as a software package including a database populated with the information relating to target brand users.

At step 210, the engagement activity can be finalized with digital and visual architectural features. The engagement activity can have features designed to resonate with a target user's life motivators and/or brand motivators. That is, the engagement activity can be designed to press “hot button” motivators. The systems and methods can train and energize target brand users to engage in the engagement activity, thereby socially amplifying trial and use of the subject branded product.

At step 212 a fully developed engagement activity can be developed and deployed to target brand users, who can then become “mission equipped” to participate in the engagement activity. The participation of target brand users in the engagement activity can be realized via, for example, a downloadable app, as is known in the art. The downloaded app can be the tool used for a target brand user to engage in the engagement activity, either solely, or in combination with other electronic devices, such as laptops, tablets, desktop computers, and the like. The activities of the target brand user can be shared passively or actively by the system or by the target brand user. The sharing of engagement activity can be accomplished through social media channels, driving conversion to purchase by other consumers, including trial and use of the subject branded produce. The conversion numbers and/or rate can be converted to metrics utilized to measure the reach of sharing, as well as the conversion rate of new branded product consumption.

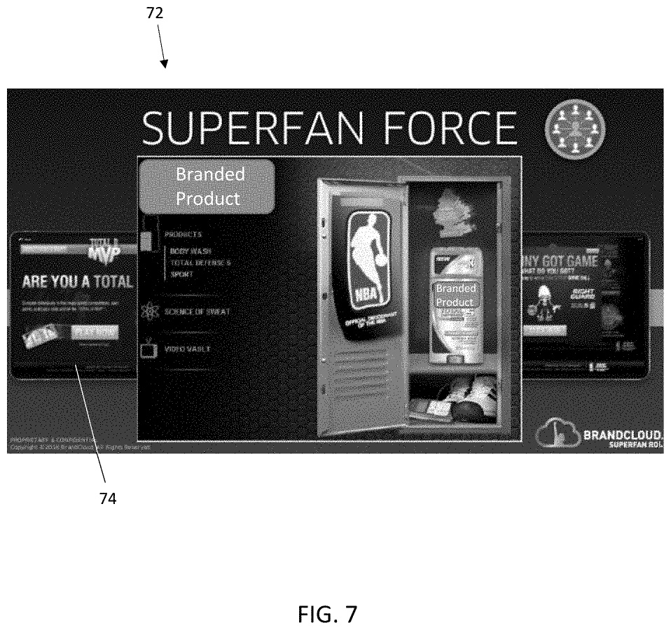

As depicted in FIG. 7 showing an exemplary digital engagement consumer-facing offer 72, the engagement activity can be in the form of a game 74, and can be displayed in a visual context relevant to the branded product. The engagement activity can have challenge features, such as a leaderboard, virtual currency, points, levels, and the like. The engagement activity can also offer redemption rewards. The redemption rewards, including coupon-driven trial, can be tracked digitally and accurately recorded and reported to the branded product producer or marketing manager. Target users, now identified as, for example, a “Superfan Force” can be harnessed to interact with the engagement activity or activities by playing the engagement activity online games, winning virtual currency, and/or gaining points or levels, all willingly as a loyal fan of the branded product.

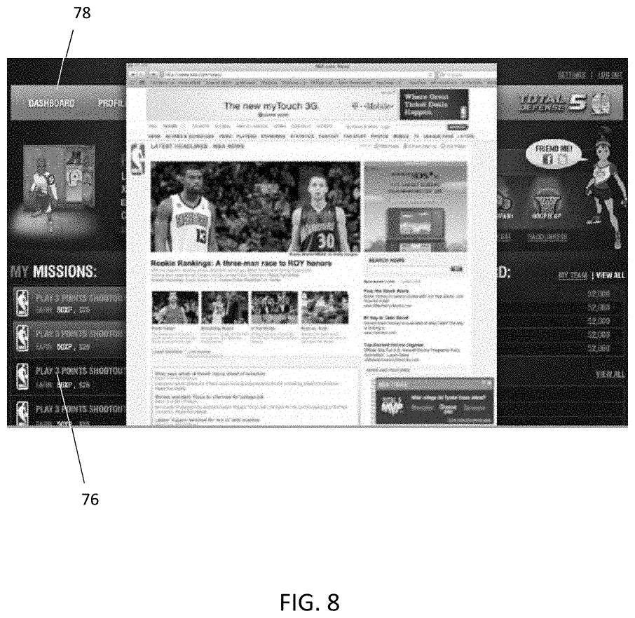

As shown in FIG. 8, the engagement activity can be formulated as a challenge or a “mission” to be accomplished, with one or more challenges 76 being offered on a dashboard 78 that facilitates target brand user engagement.

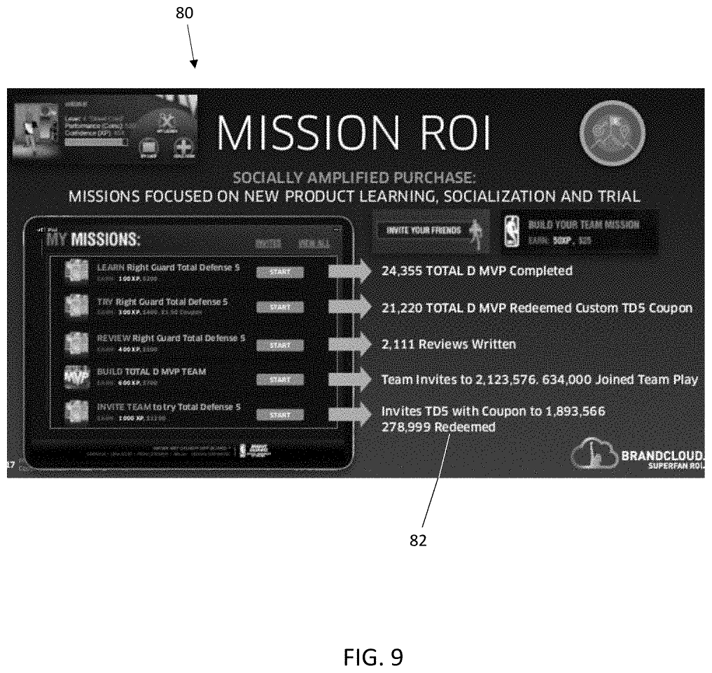

At step 214, and as depicted in FIG. 9, data analytics, including analytics that have been analyzed and optimized, can be visualized 80 and reported, including with quantified results 82. In an embodiment, actual conversion rates can be compared to forecasted conversion rates. The conversion rate of interest can be the percentage of users who take a desired action based on the actions of the target brand users in using the engagement activity. In an embodiment, the conversion rate can be the percentage of web site visitors who buy the subject branded product in the relevant time period, e.g., during the service provider's program implemented for the client via the SaaS system. In an embodiment, the conversion rate is the number or percentage of redeemed custom coupons introduced in the campaign and made available by target brand users engaged in the engagement activities. in an embodiment, the success of the campaign can be measured and visualized by the total engagement activities completed, the number of reviews written, the number of team invites with our without a coupon, and the like.

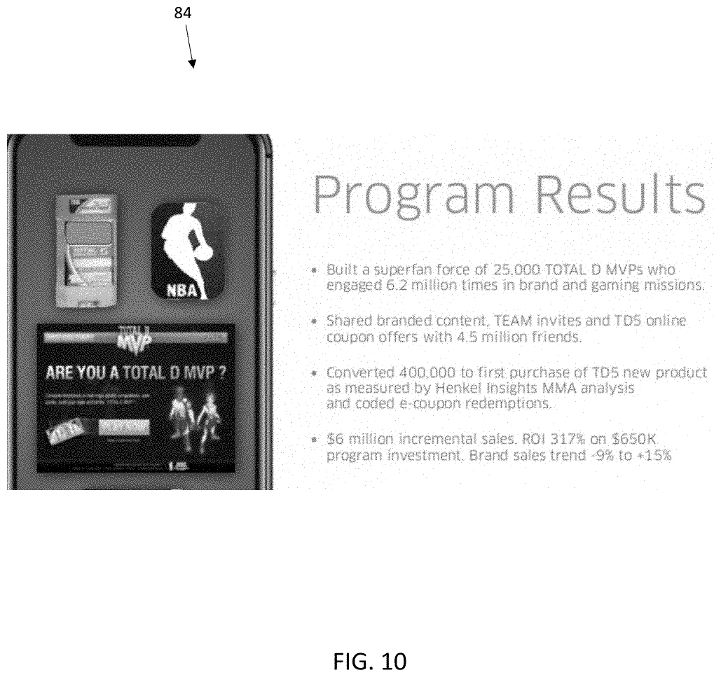

At step 216, and as shown in an exemplary embodiment in FIG. 10, the service provider can prepare a report to present findings 84 of the campaign and, optionally renew the campaign with the same or modified target brand users, engagement activities, and/or branded products in mind.

The foregoing description of embodiments and examples has been presented for purposes of illustration and description. For example, the systems and methods disclosed herein can use real-time user analytics, provide for customizable brand engagement, social amplification and tracking, trackable retail and e-commerce offers and rewards, retail geotargeting and geofencing, virtual currency and brand e-commerce. Moreover, the systems and methods herein can act as a CRM integration that will work with the brand's existing CRM APIs such as Salesforce, HubSpot, Oracle, etc. and segment target brand user profiles in the VIP group from the average customer population. This allows for psychographically customized and personalized messaging and offers. Recruiting efforts can lead to progressive engagement starting with an initial engagement, engagement and community, user creation and contribution, and resulting in sharing and advocacy for the brand.

It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A method for driving trial of a branded product, the method comprising the steps of:
a. defining objectives for a marketing campaign;
b. discovering target brand users, wherein the target brand users comprise loyal branded product users;
c. determining life motivators of the target brand users;
d. determining brand motivators of the target brand users;
e. designing an online engagement activity related to the branded product; wherein the online engagement activity tracks conversion rates related to the branded product; and
f. engaging the target brand users in use of the online engagement activity.

2. The method of claim 1, further comprising reporting results of the online engagement activity.

3. The method of claim 1, wherein the online engagement activity is a game.
